(19) United States
(12) Patent Application Publication
(10) Pub. No.: US 2010/0110658 A1
(43) Pub. Date: May 6, 2010

(54) SEMI-DIRECT SOLID STATE LIGHTING FIXTURE AND DISTRIBUTION

(76) Inventor: Donald A. Peifer, Mountain View, CA (US)

Correspondence Address: HESLIN ROTHENBERG FARLEY & MESITI PC, 5 COLUMBIA CIRCLE, ALBANY, NY, 12203, US

(21) Appl. No.: 12/576,008

(22) Filed: Oct. 8, 2009

Related U.S. Application Data
(60) Provisional application No. 61/103,638, filed on Oct. 8, 2008.

(51) Int. Cl. F21V 13/00; F21S 8/10; F21S 4/00; F21S 8/00

(52) U.S. Cl. 362/33; 362/317; 362/249.02; 362/147

(57) ABSTRACT

In one embodiment of the present invention, a suspendable semi-direct lighting fixture is provided for illuminating a work surface. The suspendable semi-direct lighting fixture includes a downlighting fixture portion, and a solid state uplighting fixture portion disposable above the downlighting fixture portion. The downlighting fixture portion and the solid state uplighting fixture portion are suspendable below a ceiling, and the solid state uplighting fixture portion is operable to emit light substantially in a 90-135 degree zone and substantially not in a 135-180 degree zone. An auxiliary solid state uplighting fixture for use with a downlighting fixture is also disclosed. Methods employing such lighting fixtures are further disclosed.

### CROSS-REFERENCE TO RELATED APPLICATION

This application claims the benefit of U.S. Provisional Application No. 61/103,638, filed Oct. 8, 2008, entitled “Semi-Direct Solid State Lighting Fixture and Distribution”, which application is incorporated in its entirety herein by reference.

### FIELD OF THE INVENTION

The present invention relates generally to lighting fixtures or luminaires, and more specifically, to solid state lighting fixtures or luminaires such as LED lighting fixtures for use in semi-direct lighting.

### BACKGROUND OF THE INVENTION

Lighting accounts for a large portion of the energy used in this country. In commercial lighting applications alone, lighting accounts for 40-percent of the energy used. Because of inherent efficiencies relative to all other lighting technologies, solid state lighting devices are poised to replace incandescent and fluorescent based lighting systems in most applications.

Finding a suitable fixture profile and form factor is important for the adoption of replacement technology into existing build environments. Considerable application issues face the common screw-based, LED, incandescent replacement lamps. One form factor that holds great promise is the solid state lighting thin panel, which is capable of being used in common drop-in ceilings as a replacement for the currently ubiquitous fluorescent troffer such as an inverted trough suspended from a ceiling as a fixture for fluorescent lighting tubes. Since they are thin, they can be used in zero plenum applications where overhead space is prohibitive. The fixtures can also be easily suspended for direct and semi-direct use.

In office lighting applications, lighting systems need to meet a mandate for minimum illumination standards, namely 20-50 foot candles on the work surface throughout the space. In order to achieve these values as a one-to-one replacement for fluorescent fixtures, solid state lighting panel fixtures would desirably deliver a minimum of 3,500 lumens. The luminance profile of a fixture providing this amount of light is also important in office lighting applications.

Therefore, there is a need for further lighting fixtures or luminaires, and more specifically, to solid state lighting fixtures or luminaires such as LED lighting fixtures for use in semi-direct lighting.

### SUMMARY OF THE INVENTION

In a first aspect, the present invention provides an auxiliary solid state uplighting fixture for use with a downlighting fixture. The auxiliary solid state uplighting fixture includes a solid state uplighting device disposable above the downlighting fixture. The solid state uplighting device is operable to emit light substantially in a 90-135 degree zone and operable to substantially not emit light in a 135-180 degree zone.

In a second aspect, the present invention provides a suspendable semi-direct lighting fixture for illuminating a work surface. The suspendable semi-direct lighting fixture includes a downlighting fixture portion, and a solid state uplighting fixture portion disposable above the downlighting fixture portion. The downlighting fixture portion and the solid state uplighting fixture portion are suspendable below a ceiling, and the solid state uplighting fixture portion is operable to emit light substantially in a 90-135 degree zone and substantially not in a 135-180 degree zone.

In a third aspect, the present invention provides a solid state lighting fixture for illuminating a work surface. The solid state lighting fixture includes a lower solid state lighting fixture portion and an upper solid state lighting fixture portion. The lower solid state lighting fixture portion includes a solid state light source, a generally horizontally disposed, planar elongated light guide for receiving light from the solid state light source and emitting the light from a generally horizontally disposed lower surface of the lower solid state lighting fixture portion, and a reflector disposed adjacent to a second horizontal surface of the light guide for redirecting some of light from the surface back into the light guide. The lower solid state lighting fixture portion is configured to produce non-polarized light having a generally vertical and horizontal Lambertian spatial power distribution to generally accurately reproduce colors of objects on the work surface. The upper solid state lighting fixture portion is disposed above the lower solid state light source. The upper solid state lighting fixture includes a solid state light source operable to emit light substantially in a 90-135 degree zone and substantially not in a 135-180 degree zone.

In a fourth aspect, the present invention provides a solid state lighting fixture for illuminating a work surface. The solid state lighting fixture includes a solid state light source, and a generally horizontally disposed, planar elongated light guide for receiving light from the solid state light source and emitting some of the light downwardly from a generally horizontally disposed lower surface and emitting other of the light upwardly from a generally horizontally disposed upper surface. The solid state lighting fixture is configured to emit non-polarized light downwardly having a generally vertical and horizontal Lambertian spatial power distribution and emit light upwardly substantially in a 90-135 degree zone and substantially not in a 135-180 degree zone which upwardly and downwardly emitted light is operable to generally accurately reproduce colors of objects on the work surface.

In a fifth aspect, the present invention provides a method for illuminating a work surface. The method includes providing the auxiliary solid state lighting fixtures or solid state lighting fixtures as noted above, suspending the auxiliary solid state lighting fixtures or the solid state lighting fixtures below a ceiling, and illuminating the work surface with light emitted downwardly and with light emitted upwardly and reflected off at least one of the ceiling and a wall.

In a sixth aspect, the present invention provides a method for illuminating a work surface. The method includes providing a plurality of the auxiliary solid state lighting fixtures or solid state lighting fixtures as noted above, suspending respective ones of the auxiliary solid state lighting fixtures or plurality of the solid state lighting fixtures in spaced-apart relationship below a ceiling, and illuminating the work surface with light emitted downwardly and with light emitted upwardly and reflected off at least one of the ceiling and a wall.

### BRIEF DESCRIPTION OF THE DRAWINGS

The subject matter which is regarded as the invention is particularly pointed out and distinctly claimed in the concluding portion of the specification. The invention, however, may best be understood by reference to the following detailed description of various embodiments and the accompanying drawings in which:

FIG. 1 is a polar plot illustrating a direct spatial power distribution for a light source;

FIG. 2 is a polar plot illustrating a semi-direct spatial power distribution for a light source;

FIG. 3 is a polar plot illustrating an indirect spatial power distribution for a light source;

FIG. 4 is a polar plot illustrating a semi-indirect spatial power distribution for a light source;

FIG. 5 is a polar plot illustrating a “rabbit ears” or V-shaped spatial power distribution for a light source in accordance with the present invention;

FIG. 6 is an elevational view of a plurality of lighting fixtures;

FIG. 7 is an intensity distribution curve or polar plot for a recessed LED panel lighting fixture not having a rabbit ears spatial power distribution;

FIG. 8 is a top view of a recessed ceiling plan employing a plurality of recessed LED panel light fixtures having the intensity distribution curve shown in FIG. 7;

FIG. 9 is a top view of a recessed ceiling plan employing a plurality of recessed LED panel light fixtures having rabbit ears distribution in accordance with the present invention;

FIG. 10 is a top perspective view of one embodiment of a rabbit ears semi-direct lighting fixture in accordance with the present invention;

FIG. 11 is a partial cross-sectional view of one embodiment of a lower lighting fixture portion of the rabbit ears semi-direct solid state lighting fixture of FIG. 10;

FIG. 12 is a perspective view of another embodiment of an indirect uplighting fixture portion for emitting light having a rabbit ears spatial power distribution in accordance with the present invention;

FIG. 13 is a perspective view of another embodiment of an indirect uplighting fixture for emitting light having a rabbit ears spatial power distribution;

FIG. 14 is a partial cross-sectional view of another embodiment of a direct downlighting fixture portion in accordance with the present invention;

FIG. 15 is a side elevational view of another embodiment of a solid state lighting fixture having a reflector for semi-direct rabbit ears lighting in accordance with the present invention;

FIG. 16 is a side elevational view of another embodiment of a solid state lighting fixture having a prism sheet for semi-direct rabbit ears lighting in accordance with the present invention; and

FIG. 17 is a cross-sectional view of a light emitting diode having an optic for directing light in about a 20-degree to 30-degree cone.

### DETAILED DESCRIPTION OF THE INVENTION

The present invention is directed to solid state fixtures or luminaires such as employing a plurality of LEDs and having a unique spatial power distribution, which optimizes the luminous intensity in certain zones. As described in greater detail below, the present invention is directed to solid state lighting fixtures or luminaires in which some of the light is directed upwardly.

Luminous flux is the time rate of flow of light. Luminous flux can be compared to electric current, in amperes, the time rate of flow of an electric charge. The unit of measure of luminous flux is the lumen. A lamp or light source receives watts and emits lumens. The measure of its success in doing this is called efficacy and is measured in lumens per watt.

While measuring the wattage of a light source is relatively straight forward, the method for determining the total lumens of a lighting device is a function of the distribution of the light source. Lighting intensity is often graphically represented in polar plots. The polar plots allow for the visualization of the spatial power distribution of the light, i.e., the shape of the beam.

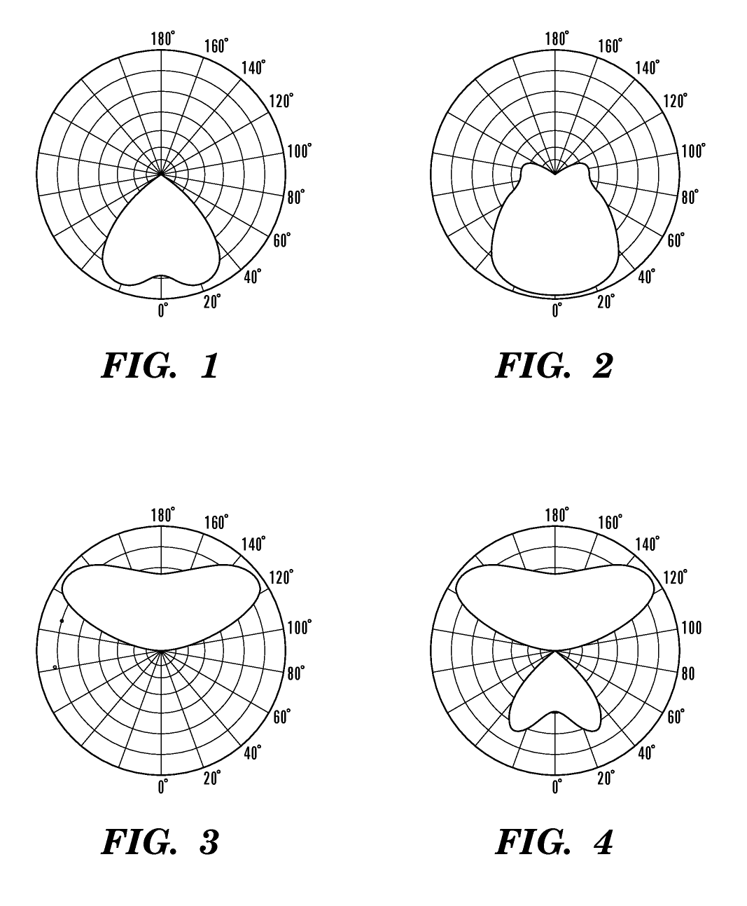

FIG. 1 illustrates a direct spatial power distribution for a light source where 90-percent to 100-percent of the fixture's generated light is directed downwardly towards the work plane. This is a popular light distribution and includes many recessed fixtures.

FIG. 2 illustrates a semi-direct spatial power distribution for a light source. Semi-direct light distribution is characterized by 60-percent to 90-percent of the light directed downwards and 10-percent to 40-percent directed upwards. An example of semi-direct light is a wall sconce fixture with a hole in the top.

FIG. 3 illustrates an indirect spatial power light distribution where 90-percent to 100-percent of the light is distributed upwards, and it is common in commercial lighting, where bright beams of light are directed into the ceiling. The light that gets to the work surface is 100-percent reflected or indirect.

FIG. 4 depicts a semi-indirect light distribution where 10-percent to 40-percent of the light is directed downward and 60-percent to 90-percent is directed upwards. This is also common in commercial lighting fixtures, especially for fluorescent tube lighting fixtures.

Luminous intensity, also referred to as candlepower, is light emitted in a particular direction. Luminous intensity is measured in candelas (cd). The polar plot consists of candela readings around the light source. The polar plot can be broken up into pie-shaped zones. For examples, 0-10 degree and 90-120 degree are both examples of zones. Each zone has a zonal constant associated with it. By multiplying the zonal constant by the average of the candela readings within a zone, zonal lumens are arrived at. Total lumens for a light fixture can be derived through the sum of all the zonal lumens for a fixture.

The following table illustrates the zonal constants for 0 to 180 degrees:

| Zone | Constant |
|---|---|
| 0-30 | 0.841 |
| 30-60 | 2.299 |
| 60-90 | 3.142 |
| 90-120 | 3.142 |
| 120-150 | 2.299 |
| 150-180 | 0.841 |

In direct fixtures, 100-percent of the light is in the 0-90 degree zone. In this case, the zonal constants gradually increase as the zonal angles increase away from 0-degrees. In order to maximize the total luminous flux, one strategy for designing fixtures is to maximize the output in the more obtuse angles (45-degrees to 90-degrees). This will allow candela readings to benefit from higher zonal constants. There is a lighting industry mandate, however, that fixtures meet a zonal lumen density requirement. It states that the luminaire shall deliver a minimum of 75-percent of total lumens within the 0-60 degree zone.

It is difficult to create an optimized distribution for direct fixtures within only 90 degrees of distribution. Semi-direct fixtures, on the other hand, offer the potential to maximize total lumens by utilizing the zonal constants for the 90-180 degree zone. As can be seen from the table above, the zonal constants for the 90-180 degree zone are the mirror image of the 0-90 degree zone. A potential for maximizing total lumens is to direct light substantially into the 90-135 degree zone, and desirably substantially within the 90-120 degree zone where the zonal constant is 3.14. Further, it may also be desirable to direct the light substantially in a 100-120 degree zone as the light emitted horizontally (90-100 degree zone) may need to travel a distance before being reflected off the walls.

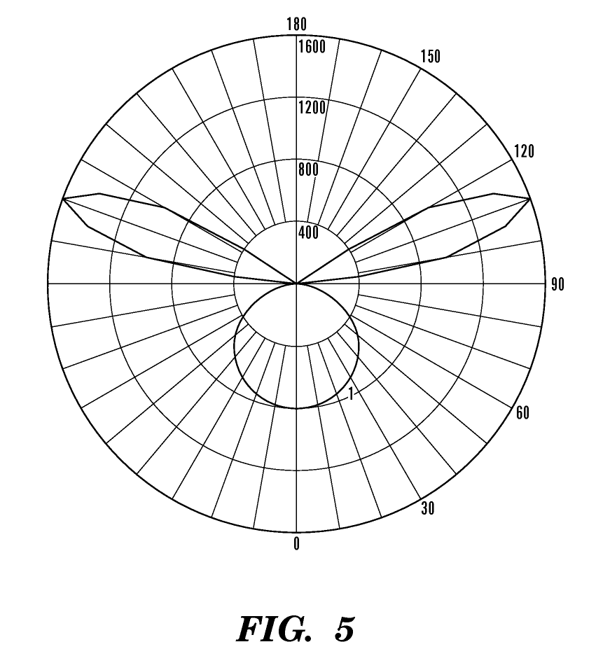

FIG. 5 illustrates a semi-direct spatial power distribution having a “rabbit ears” or V-shaped light distribution in accordance with the present invention. The semi-direct spatial power of FIG. 5 may be generated using a semi-direct solid state lighting system having a unique spatial power distribution, which optimizes the luminous intensity in certain zones. This may be accomplished by creating an optimized cosine distribution in the 0-90 degree zone supplemented by sharp spikes in the luminous intensity in the 90-120 degree zone. The luminous intensity in the 120-180 degree zone tapers rapidly off to zero. It is noted that the rabbit ears or V-shaped distribution of light may be rotated 360-degrees about the 180-degree axis and define a conical surface having an obtuse angle along which the light is directed. It is also noted that the light need not be emitted entirely around the 180-degree axis nor does the light need be emitted uniformly around the 180-degree axis. The downwardly emitted light may have a cosine distribution or approximately a horizontal and vertical Lambertian spatial power distribution. For example, the configuration or pattern of of the light may be rotationally symmetric.

One advantage of the rabbit ears distribution is its effect on spacing criteria (SC) and subsequently the lighting power allowance for an installation. The spacing criteria is different for each light source, and it is a part of a mounting height ratio used when installing fixtures in specific installations (Spacing/Mounting Height).

SC×Mounting Height=Recommended spacing of fixtures

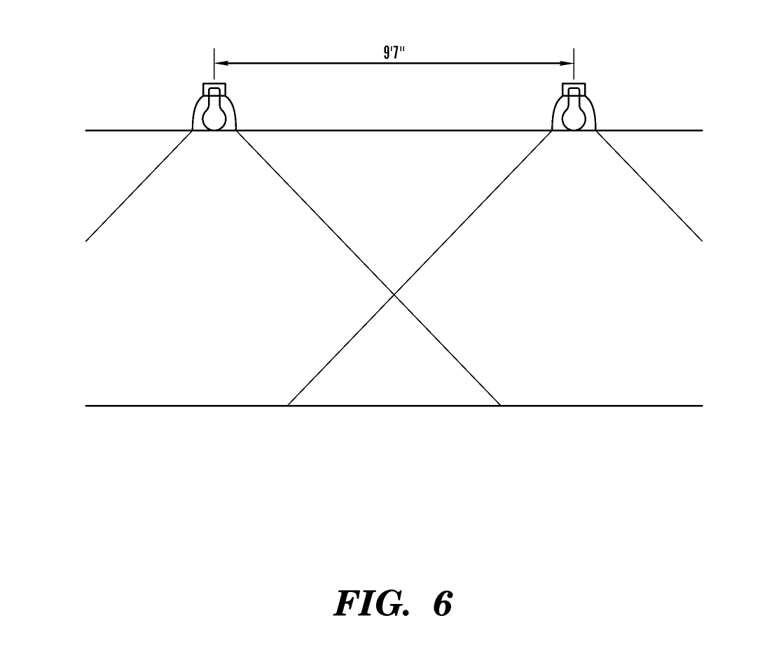

FIG. 6 illustrates an example of the mounting height ratio to assure even distribution of light in a space. For example, if a manufacturer's SC=1.2 and the ceilings are 8-feet high, the maximum spacing between fixtures will be 8×1.2=9.6 feet (9 feet and 7 inches).

As described below, rabbit ear distribution in accordance with the present invention allows for a much higher spacing criteria for an identical wattage light source.

Lighting power allowance (LPA) or power density is the basic unit measuring the efficiency of a lighting installation. It is measured in watts per square feet. Spacing criteria affects LPA. The higher the spacing criteria, the fewer lighting fixtures needed to assure continuous illumination and the meeting of minimum illumination standards. With fewer light fixtures, the less the wattage is per square foot. Some common LPA mandates for certain energy efficiency programs by space type are: open office LPA=1.4 (maintaining 30 FC illumination); retail space LPA=1.9 (30 FC) and Lobby LPA=0.9 (10 FC). Meeting or matching these targets qualifies a light fixture as energy saving or efficient.

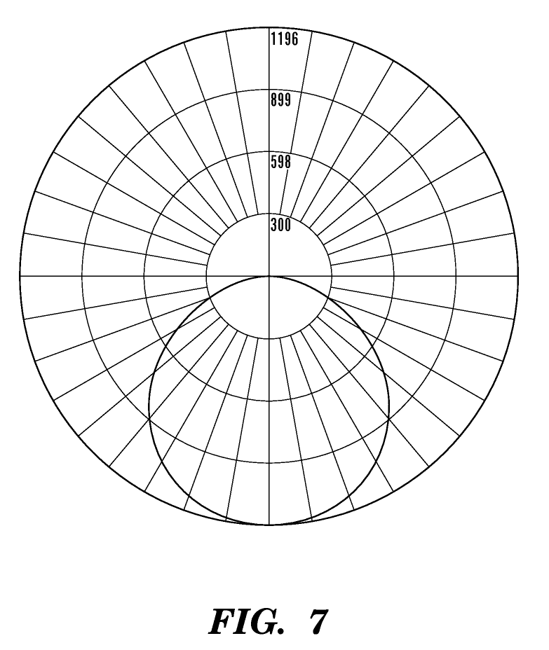

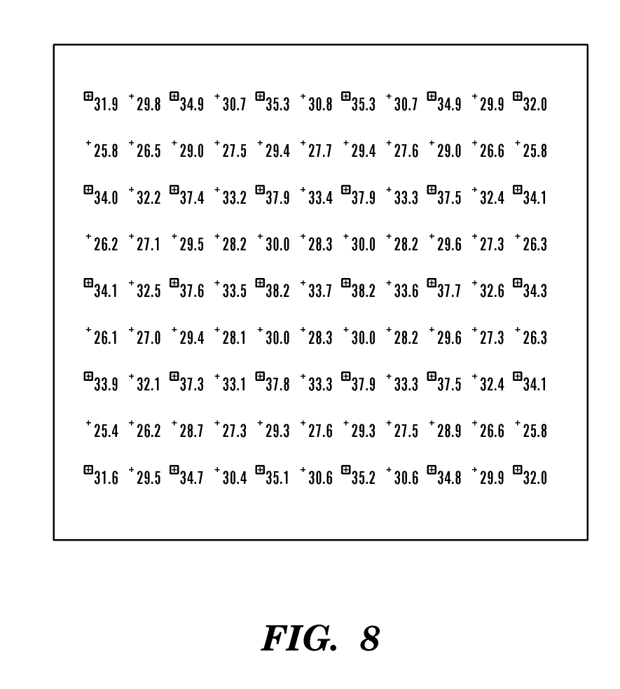

FIG. 7 illustrates a polar plot or intensity distribution curve for a recessed LED panel light fixture that does not exhibit rabbit ear distribution. The shape of the beam as illustrated is almost perfectly round or cosine distribution having a generally horizontal and vertical Lambertian spatial power distribution, e.g., the source may be almost perfectly diffusing. Its output is very near optimized for a direct lighting fixture type. The lighting fixture's total luminous flux is 3,400 lumens. Its wattage is 68 watts with system efficacy of 50 lumens/watt. Using an industry standard, light rendering software program, Visual, the direct type fixture was programmed into a standard commercial type space. Standard reflectances for walls, ceilings, and floors were given along with standard 10 foot ceiling height. The results indicated that 30 direct fixtures are needed to maintain an average 30 FC illuminance level (minimum standards are 20 FC). This resulted in an LPA of 0.6 watts per square foot. This represents over a 50-percent reduction in LPA for average commercial spaces. The results are shown in FIG. 8 which illustrates a recessed ceiling plan looking down at the fixture layout. The walls bound the fixtures, the squares represent the recessed lighting fixtures, and the numbers indicate the foot candle readings throughout the space.

Another benefit of rabbit ear distribution is an increase in total lumens. A lighting fixture exhibiting the rabbit ears light distribution shown in FIG. 5 was created from the same panel fixture type employed in FIG. 8, with the exception that 33-percent fewer of the die (LEDs) were used in the 0-90 degree range. The 33-percent of the die (LEDs) not used to create the direct cosine distribution were mounted on the top of the lighting fixture to create a candela spike in the 90-120 degree zone. Clear, prismatic, brightness enhancement films were used to enhance the spikes or rabbit ears shown in FIG. 5. The film is available from Vikuiti, a subsidiary of 3M of St. Paul, Minn., model no. BEF III.

The combination created a total luminous flux greater than with just the LED emitting light downwardly, e.g., the system efficacy was greater compared to the system efficacy for the direct distribution fixture. Since the fixture by definition of being semi-direct is suspended closer to the work plane, less output is needed for the direct component of the fixture in order to meet minimum illumination standards. The resulting increase in spacing criteria can be seen by placing the semi-direct fixture into the same Visual program with matching parameters.

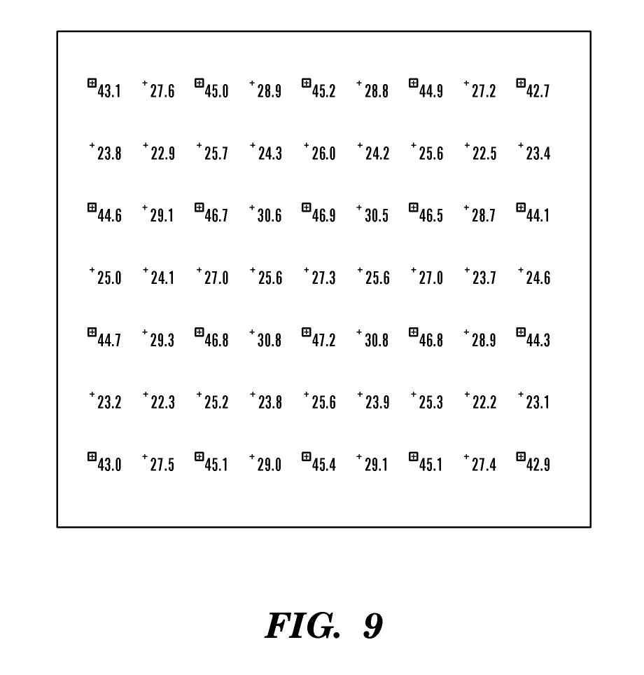

The results are shown in FIG. 9 which illustrates a recessed ceiling plan looking down at the fixture layout. The rabbit ear distribution fixtures needed only 20 fixtures compared to the 30 fixtures needed for the direct cosine distribution fixture. The LPA for the rabbit ear distribution fixture is 0.38 watts per square foot as opposed to 0.6 for the direct fixture.

These surprising results show by, in effect, taking some of the LEDs from a direct type fixture and arranging them on top of the fixture to enhance the spatial power distribution in the substantially 90-135 degree zone (90-120 degree zone, or 100-120 degree zone), and substantially not in a 135-180 degree zone (or 120-180 degree zone), one goes from an efficacious light source to an even better efficacious light source. The potential for energy savings and reducing capital costs in lighting may be large.

The unique lighting fixture of the present invention may employ various different configurations. The general technique is to arrange the LEDs, any size may be appropriate, on top of the panel fixture so that there is lateral symmetry around the horizontal angles of the fixture. The closer the LEDs are disposed toward the center of the fixture, the fewer LEDs need to be used.

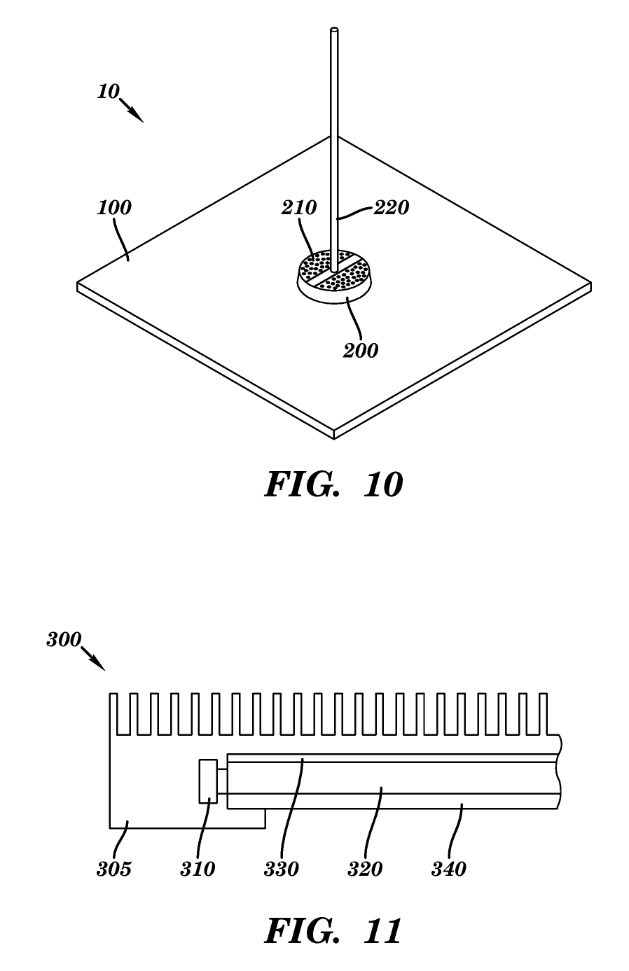

FIG. 10 illustrates one embodiment of a rabbit ears semi-direct lighting fixture 10 which includes an indirect lighting module 200 placed on top of a flat solid state direct lighting fixture panel 100. In this example, module 200 has a circular shape. LED modules inside the module 200 direct emitted light along the angled surface of module 200 in substantially in a 90-120 degree zone and substantially not in the 120-180 degree zone. Indentations 210 illustrate a heat sink. A signal/power cord 220 allows for supply or electrical power to the lighting fixture.

FIG. 11 illustrates a partial cross-sectional view of an exemplary embodiment of a downlighting lighting fixture or portion 300 in accordance with the present invention which includes an optical element such as a single diffuser. In this example, a series of optical elements are bound by a frame 305. Light is emitted from a solid state device 310 such as at least one light emitting diode and preferably a plurality of LEDs into a light guide 320. Light may be prohibited from exiting the top of the fixture by the reflector 330 and redirected back into the light guide 320. The reflector may be a specular reflector (e.g., a mirror), a diffuse reflector (e.g., a white opaque material), or material operable to provide a combination of specular or diffuse reflection. For example, the reflector may be a MYLAR or polyester film containing titanium dioxide. Light exiting the light guide then passes through a diffuser 340. The light exiting the diffuser is directed directly towards a work surface.

Desirably, the downlighting lighting fixture or portion may emit non-polarized light having a generally vertical and horizontal Lambertian spatial power distribution to generally accurately reproduce colors of objects on the work surface. For example, downlighting lighting fixture or portion which emit non-polarized light having a generally vertical and horizontal Lambertian spatial power distribution to generally accurately reproduce colors of objects on the work surface are disclosed in U.S. patent application Ser. No. 12/572,587, filed Oct. 2, 2009, entitled “Optimized Spatial Power Distribution For Solid State Light Fixtures”, the entire subject matter of which is incorporated herein by reference.

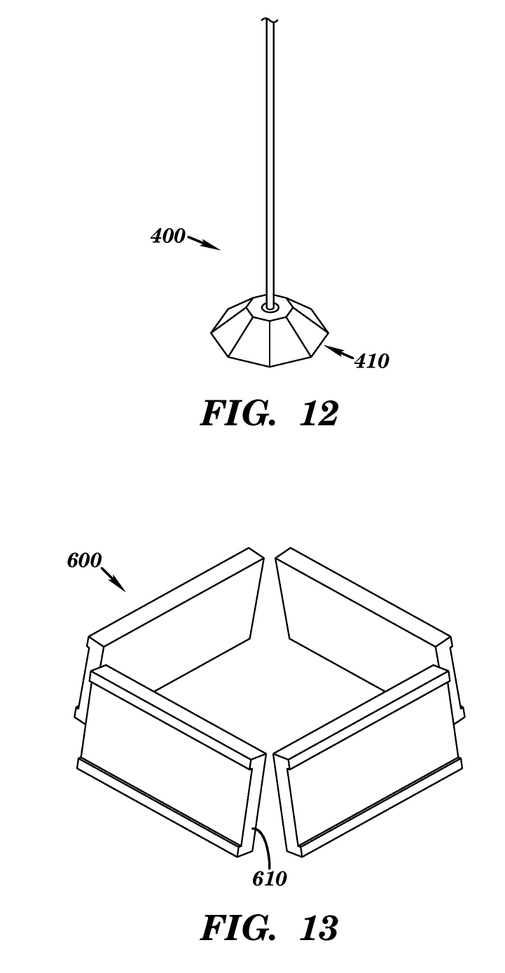

FIG. 12 illustrates another embodiment for an indirect portion 400 of a rabbit ear semi-direct lighting fixture (i.e., the direct portion of the rabbit ear semi-direct lighting fixture not being shown in FIG. 12). Indirect portion 400 may include an octagonal shaped indirect lighting LED module 410, which sits on the top of a direct lighting fixture.

FIG. 13 illustrates another embodiment for an indirect portion 600 of a rabbit ear semi-direct lighting fixture comprising an array of a plurality of lighting panels 610 such as four individual lighting panels mounted facing outwardly along four sides of a square, and inclined at an appropriate angle to direct emitted light into the 90-120 degree zone. For example, each rectangular unit may include LED's and suitable secondary or directional optics within a housing.

Other arrangements which provide the desired “rabbit ears” light distribution exemplified in FIG. 5 may also be advantageously employed in accordance with the present invention.

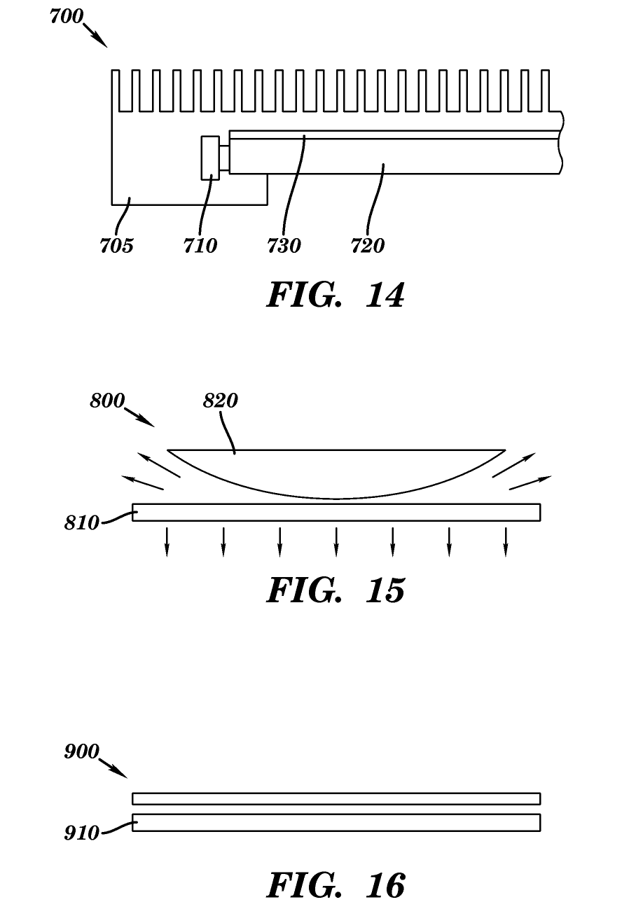

FIG. 14 illustrates a partial cross-sectional view of an exemplary embodiment for the direct portion 700 of a rabbit ears semi-direct lighting fixture in accordance with the present invention. In this example, a series of optical elements are bound by a frame 705. Light is emitted from an LED device 710 such as at least one light emitting diode and preferably a plurality of LEDs into a light guide 720. Light may be prohibited from exiting the top of the fixture by the reflector 730 such as a specular reflector (e.g., a mirror) or diffuse reflector (e.g., a white opaque material), and redirected back into the light guide 720. For example, the reflector may be a MYLAR or polyester film containing titanium dioxide. Light, such as non-polarized light, exiting the light guide along the bottom of the light guide may be used to illuminate the object on a work surface.

It will be appreciated by those skilled in the art that the diffuser, light guide itself, of other means may be employed to frustrate total internal reflection (TIR) and to distribute the light emitted from the solid state light sources uniformly across the light-guide surface. For example, rulings (such as scratches) on the surface of the light guide, dots of white paint painted on the surface of the light guide, etc. may be employed with a reflector to more closely approximate a vertical and horizontal Lambertian spatial power distribution. For example, the number of or density of dots or rulings on the light guide may be greater further away from the solid state light source than the number of or density of dots or rulings closer to the solid state light source.

In another aspect, the present invention is directed to an auxiliary solid state uplighting fixture having the rabbit ears distribution of light for use with and supplementing the light emitted from other lighting fixtures. For example, with lighting fixtures such as suspended downlighting fixtures, the top of the downlighting fixture and the ceiling above the downlighting fixture are typically dark. The top of the downlighting fixture and the ceiling above the downlighting fixture may be supplemented with light emitted from an auxiliary solid state uplighting fixture. For example, conventional florescent lighting fixtures, conventional solid state lighting fixtures, and other lighting fixtures may be supplemented with an auxiliary solid state uplighting fixture having the rabbit ears distribution of light.

The auxiliary solid state uplighting fixture may include a solid state uplighting device (such as shown in FIGS. 12 and 13) disposable above the downlighting fixture. As noted above, the solid state uplighting device may be operable to emit light substantially in a 90-135 degree zone and operable to substantially not emit light in a 135-180 degree zone, and the other above-noted zones. The solid state uplighting device may also be operable to emit the light substantially above and around the perimeter of the downlighting fixture. The solid state uplighting device may comprise a plurality of light emitting diodes.

The auxiliary solid state uplighting fixture may further include means for electrically connecting and suspending the auxiliary solid state uplighting fixture from a ceiling, and means for electrically connecting the downlighting fixture to the auxiliary solid state uplighting fixture. For example, the auxiliary solid state uplighting fixture my include an electrical cord or cable for connecting the auxiliary solid state uplighting fixture to an electrical box on the ceiling. The auxiliary solid state uplighting fixture may also include an electrical connection or outlet for readily electrically connecting to the downlighting fixture. The auxiliary solid state uplighting fixture and the downlighting fixture may be suitable connected together with bolts, screws, or other connecting means.

The auxiliary solid state uplighting fixture may also be operable to produce light substantially in the 100-120 degree zone and substantially not in the 90-100 zone and 120-180 zone, and emit the light substantially above and around the perimeter of the downlighting fixture.

In another aspect, the present invention is directed to auxiliary solid state uplighting fixtures augmenting the color rendering of the light emitted from the downlighting fixture. The auxiliary solid state uplighting fixtures may emit a spectrum of light that is different from the spectrum of light emitted from the downlighting fixture. For example, the downlighting fixture may be a fluorescent lighting fixture having a low color rendering index (e.g., which lacks light in the red spectrum). Thus, an auxiliary solid state uplighting fixture may be used to emit light having a greater portion of light in the red spectrum and optimize the resulting light emitted from both the downlighting fixture and the light emitted from the auxiliary solid state uplighting fixture and reflected off the ceiling and walls to enhance or produce light that more closely reproduces colors of objects compared to the reproduction of colors with just the downlighting fixture.

Another embodiment of the invention is directed to a solid state lighting fixture having a light guide with is operable to emit light downwardly, as well as emit light upwardly having the rabbit ears light distribution.

For example, a solid state lighting fixture for illuminating a work surface may include a solid state light source, and a generally horizontally disposed, planar elongated light guide for receiving light from said solid state light source and emitting some of the light downwardly from a generally horizontally disposed lower surface and emitting other of the light upwardly from a generally horizontally disposed upper surface.

The solid state lighting fixture may be configured to emit non-polarized light downwardly having a generally vertical and horizontal Lambertian spatial power distribution, as described above, and emit light upwardly substantially in a 90-120 degree zone and substantially not in the 120-180 zone to generally accurately reproduce colors of objects on the work surface.

For example, the solid state lighting fixture may be configured to emit light upwardly from substantially a center of the solid state lighting fixture, and emit the light upwardly substantially around the perimeter of the solid state lighting fixture.

FIG. 15 illustrates one embodiment of a solid state lighting fixture 800 having a lighting device 810 which may include a solid state light source, and a generally horizontally disposed, planar elongated light guide for receiving light from the solid state light source, and a reflector having a plurality of holes to allow some of the light in the light guide to exit upwardly. A reflector 820 may be positioned above the lighting device 810 for reflecting light having the rabbit ears light distribution. The reflector may be a convex mirror, or other suitable reflector.

FIG. 16 illustrates another embodiment of a solid state lighting fixture 900 having a lighting device 910 which may include a solid state light source, and a generally horizontally disposed, planar elongated light guide for receiving light from the solid state light source, and a reflector having a plurality of holes to allow some of the light in the light guide to exit upwardly. Disposed on top of the reflector may be a prism film operable to direct the light emitted upwardly into the rabbit ear distribution. It will be appreciated that other suitable means may be employed for redirecting the light upwardly in the rabbit ears distribution.

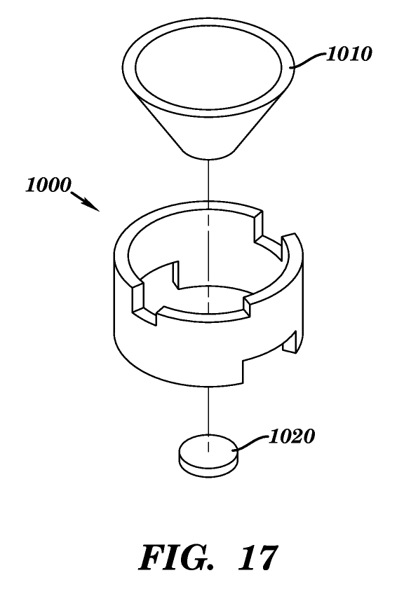

FIG. 17 is a cross-sectional view of a light emitting diode (LED) 1000 having an optic 1010 for directing or focusing light from an LED 1020 in about a 20-degree cone to about a 30-degree cone. Such LEDs having the optic may be used in the various embodiments of the auxiliary solid state lighting fixtures and the solid state lighting fixtures described above. For example, such LEDs and optics may be position on one or more desired angles for projecting the light in the rabbit ears distribution. It will be appreciated that other suitable sized and configured optics may be employed.

When viewed from below, the light emitted from the auxiliary uplighting fixture and uplighting fixture portions are desirably not seen by the observer from below. The auxiliary uplighting fixture and uplighting fixture portions may be about 6 inches to about 8 inches round or less, e.g., about 3 inches to 4 inches from a vertical axis disposed in the center of the downlighting fixture.

The above described lighting fixtures may comprises the downlighting fixture portion having a width and length of at least one of about 2 feet by about 2 feet and about 2 feet by about 4 feet, and wherein light emitted from said solid state lighting fixture comprising about 600 lumens to about 6,000 lumens.

Other exemplary embodiments for the direct portion of a rabbit ear semi-direct lighting fixture or the solid state lighting fixture having a light guide operable for emitting light downwardly and upwardly in accordance with the present invention are disclosed in U.S. patent application Ser. No. 12/572,587, filed Oct. 2, 2009, entitled “Optimized Spatial Power Distribution For State Light Fixtures”, the entire subject matter of which is incorporated herein by reference.

Thus, while various embodiments of the present invention have been illustrated and described, it will be appreciated to those skilled in the art that many changes and modifications may be made thereunto without departing from the spirit and scope of the invention.

1. An auxiliary solid state uplighting fixture for use with a downlighting fixture, said auxiliary solid state uplighting fixture comprising:
a solid state uplighting device disposable above the downlighting fixture; and
wherein said solid state uplighting device is operable to emit light substantially in a 90-135 degree zone and operable to substantially not emit light in a 135-180 degree zone.

2. The auxiliary solid state uplighting fixture of claim 1 wherein said solid state uplighting device is operable to emit the light substantially above and around the perimeter of the downlighting fixture.

3. The auxiliary solid state uplighting fixture of claim 1 wherein said solid state lighting device comprises a plurality of light emitting diodes.

4. The auxiliary solid state uplighting fixture of claim 1 further comprising means for electrically connecting and suspending the auxiliary solid state uplighting fixture from a ceiling, and means for electrically connecting the downlighting fixture to the auxiliary solid state uplighting fixture.

5. The auxiliary solid state uplighting fixture of claim 1 wherein said solid state uplighting device is operable to emit light substantially in a 90-120 degree zone and operable to substantially not emit light in a 120-180 degree zone.

6. The auxiliary solid state uplighting fixture of claim 1 wherein solid state uplighting device is operable to produce light substantially in a 100-120 degree zone and substantially not in a 90-100 degree zone and a 120-180 degree zone, said solid state uplighting device operable to emit the light substantially above and around the perimeter of the downlighting fixture, and said solid state uplighting device comprising a plurality of light emitting diodes.

7. A method for illuminating a work surface, the method comprising:
providing a downlighting fixture;
providing the auxiliary solid state uplighting fixture of claim 1;
disposing the auxiliary solid state uplighting fixture above the downlighting fixture;
suspending the downlighting fixture and the auxiliary solid state uplighting fixture below a ceiling; and
illuminating the work surface with light emitted downwardly from the downlighting fixture and with light emitted upwardly from the auxiliary solid state uplighting fixture and reflected off at least one of ceiling and a wall.

8. A method for illuminating a work surface, the method comprising:
providing a plurality of downlighting fixtures;
providing a plurality of the auxiliary solid state uplighting fixtures of claim 1;
disposing the plurality of auxiliary solid state uplighting fixture above respective ones of the plurality of the downlighting fixtures;
suspending respective downlighting fixture and auxiliary solid state uplighting fixture in spaced-apart relationship below a ceiling; and
illuminating the work surface with light emitted downwardly from the downlighting fixture and with light emitted upwardly from the auxiliary solid state uplighting fixture and reflected off at least one of the ceiling and a wall.

9. A suspendable semi-direct lighting fixture for illuminating a work surface, said suspendable semi-direct lighting fixture comprising:
a downlighting fixture portion;
a solid state uplighting fixture portion disposable above said downlighting fixture portion; and
wherein said downlighting fixture portion and said solid state uplighting fixture portion being suspendable below a ceiling, and said solid state uplighting fixture portion is operable to emit light substantially in a 90-135 degree zone and substantially not in a 135-180 degree zone.

10. The suspendable semi-direct lighting fixture of claim 9 wherein said downlighting fixture portion emits a first spectrum of light, and said solid state uplighting fixture portion emits a second spectrum of light different from said first spectrum of light, and wherein said second spectrum is operable with said first spectrum to closely reproduce colors of objects.

11. The suspendable semi-direct lighting fixture of claim 9 wherein said solid state uplighting fixture portion is operable to emit the light substantially above and around the perimeter of the downlighting fixture portion.

12. The suspendable semi-direct lighting fixture of claim 9 wherein said solid state uplighting fixture portion is disposed substantially in the center of the downlighting fixture portion to emit light substantially from the center of said solid state uplighting fixture portion.

13. The suspendable semi-direct lighting fixture of claim 9 wherein said solid state uplighting fixture portion is disposed substantially in the center of the downlighting fixture portion, and said solid state uplighting fixture portion is operable to emit the light upwardly from the center of the downlighting fixture portion, and around the perimeter of the downlighting fixture portion.

14. The suspendable semi-direct lighting fixture of claim 9 wherein said solid state uplighting fixture portion is operable to emit light substantially in a 90-120 degree zone and operable to substantially not emit light in a 120-180 degree zone.

15. The suspendable semi-direct lighting fixture of claim 9 wherein said solid state uplighting fixture portion is operable to produce light substantially in a 100-120 degree zone and substantially not in a 90-100 degree zone and a 120-180 degree zone.

16. The suspendable semi-direct lighting fixture of claim 9 wherein the downlighting fixture portion comprises a fluorescent lighting fixture.

17. The suspendable semi-direct lighting fixture of claim 9 wherein the downlighting fixture portion comprises a solid state downlighting fixture.

18. The suspendable semi-direct lighting fixture of claim 9 wherein said solid state uplighting fixture portion comprises a plurality of light emitting diodes, and wherein said solid state downlighting fixture portion comprises a plurality of light emitting diodes.

19. The suspendable semi-direct lighting fixture of claim 9 wherein said downlighting fixture portion comprises a width and length of at least one of about 2 feet by about 2 feet and about 2 feet by about 4 feet, and wherein light emitted from said solid state lighting fixture comprising about 600 lumens to about 6,000 lumens.

20. A method for illuminating a work surface, the method comprising:
providing the suspendable semi-direct lighting fixture of claim 9 having the downlighting fixture portion and the solid state uplighting fixture portion;
suspending the suspendable semi-direct lighting fixture below a ceiling; and
illuminating the work surface with light emitted downwardly from the downlighting fixture portion and with light emitted upwardly from the solid state uplighting fixture portion and reflected off at least one of the ceiling and a wall.

21. A method for illuminating a work surface, the method comprising:
providing a plurality of the suspendable semi-direct lighting fixtures of claim 9 having the downlighting fixture portion and the solid state uplighting fixture portion;
suspending respective ones of the plurality of suspendable semi-direct lighting fixtures in spaced-apart relationship below a ceiling; and
illuminating the work surface with light emitted downwardly from the plurality of downlighting fixture portions and with light emitted upwardly from the plurality of solid state uplighting fixture portions and reflected off at least one of the ceiling and a wall.

22. A solid state lighting fixture for illuminating a work surface, said solid state lighting fixture comprising:
a lower solid state lighting fixture portion comprising:
a solid state light source;
a generally horizontally disposed, planar elongated light guide for receiving light from said solid state light source and emitting the light from a generally horizontally disposed lower surface of said lower solid state lighting fixture portion;
a reflector disposed adjacent to a second horizontal surface of the light guide for redirecting some of light from the surface back into said light guide; and
said lower solid state lighting fixture portion being configured to produce non-polarized light having a generally vertical and horizontal Lambertian spatial power distribution to generally accurately reproduce colors of objects on the work surface; and
an upper solid state lighting fixture portion disposed above said lower solid state light source, said upper solid state lighting fixture comprising:
a solid state light source operable to emit light substantially in a 90-135 degree zone and substantially not in a 135-180 degree zone.

23. The solid state lighting fixture of claim 22 wherein said upper solid state lighting fixture portion is operable to emit the light substantially around the perimeter of the lower solid state lighting fixture portion.

24. The solid state lighting fixture of claim 22 wherein said upper solid state lighting fixture portion is disposed substantially in the center of the lower solid state lighting fixture portion to emit light upwardly substantially from said center of said upper solid state lighting fixture portion.

25. The solid state lighting fixture of claim 22 wherein said upper solid state lighting fixture portion is disposed substantially in the center of the lower solid state lighting fixture portion, and said upper solid state lighting fixture portion is operable to emit the light upwardly from the center of said lower solid state lighting fixture portion, and around the perimeter of the lower solid state lighting fixture portion.

26. The solid state lighting fixture of claim 22 wherein said upper solid state light lighting fixture portion comprising an upper solid state light fixture portion being operable to emit light substantially in a 90-120 degree zone and substantially not in a 120-180 degree zone

27. The solid state lighting fixture of claim 22 wherein said upper solid state light lighting fixture portion comprising an upper solid state light fixture portion being operable to emit light substantially in a 100-120 degree zone and substantially not in a 90-100 degree zone and a 120-180 degree zone.

28. The solid state lighting fixture of claim 22 wherein power to said solid state lighting fixture is distributed with about ⅔ the power supplied to said lower solid state lighting fixture portion, and about ⅓ the power supplied to said upper solid state lighting fixture portion.

29. The solid state lighting fixture of claim 22 wherein said upper and lower solid state lighting fixture portions comprise a plurality of light emitting diodes.

30. The solid state lighting fixture of claim 22 wherein said light guide comprises a width and length of at least one of about 2 feet by about 2 feet and about 2 feet by about 4 feet, and wherein light emitted from said solid state lighting fixture comprises about 600 lumens to about 6,000 lumens.

31. A method for illuminating a work surface, the method comprising:
providing the solid state lighting fixture of claim 22 having the lower solid state lighting fixture portion and the upper solid state lighting fixture portion;
suspending the solid state lighting fixture below a ceiling; and
illuminating the work surface with light emitted downwardly from the lower solid state lighting fixture portion and with light emitted upwardly from the upward solid state lighting fixture portion and reflected off at least one of the ceiling and a wall.

32. A method for illuminating a work surface, the method comprising:
providing a plurality of the solid state lighting fixtures of claim 22 having the lower solid state lighting fixture portion and the upper solid state lighting fixture portion;
suspending respective ones of the plurality of the solid state lighting fixtures in spaced-apart relationship below a ceiling; and
illuminating the work surface with light emitted downwardly from the plurality of the lower solid state lighting fixture portions and with light emitted upwardly from the plurality of the upper solid state lighting fixture portions and reflected off at least one of the ceiling and a wall.

33. A solid state lighting fixture for illuminating a work surface, said solid state lighting fixture comprising:
a solid state light source;
a generally horizontally disposed, planar elongated light guide for receiving light from said solid state light source and emitting some of the light downwardly from a generally horizontally disposed lower surface and emitting other of the light upwardly from a generally horizontally disposed upper surface;
said solid state lighting fixture being configured to emit non-polarized light downwardly having a generally vertical and horizontal Lambertian spatial power distribution and emit light upwardly substantially in a 90-135 degree zone and substantially not in a 135-180 degree zone which upwardly and downwardly emitted light is operable to generally accurately reproduce colors of objects on the work surface.

34. The solid state lighting fixture of claim 33 wherein said solid state lighting fixture being configured to emit light upwardly from substantially a center of the solid state lighting fixture.

35. The solid state lighting fixture of claim 33 wherein said solid state lighting fixture begin operable to emit the light upwardly substantially around the perimeter of the solid state lighting fixture.

36. The solid state lighting fixture of claim 33 wherein said upper solid state light lighting fixture comprising a solid state light source being operable to emit light substantially in a 90-120 degree zone and substantially not in a 120-180 degree zone.

37. The solid state lighting fixture of claim 33 wherein said upper solid state light lighting fixture comprising a solid state light source being operable to emit light substantially in a 100-120 degree zone and substantially not in a 90-100 degree zone and a 120-180 degree zone.

38. The solid state lighting fixture of claim 33 wherein said solid state light source comprises a plurality of light emitting diodes.

39. The solid state lighting fixture of claim 33 wherein said light guide comprises a width and length of at least one of about 2 feet by about 2 feet and about 2 feet by about 4 feet, and wherein light emitted from said solid state lighting fixture comprising about 600 lumens to about 6,000 lumens.

40. A method for illuminating a work surface, the method comprising:
providing the solid state lighting fixture of claim 33;
suspending the solid state lighting fixture below a ceiling; and
illuminating the work surface with light emitted downwardly from the solid state lighting fixture and with light emitted upwardly from the solid state lighting fixture and reflected off at least one of the ceiling and a wall.

41. A method for illuminating a work surface, the method comprising:
providing a plurality of the solid state lighting fixtures of claim 33;
suspending respective ones of the plurality of the solid state lighting fixtures in spaced-apart relationship below a ceiling; and
illuminating the work surface with light emitted downwardly from the plurality of the solid state lighting fixtures and with light emitted upwardly from the plurality of the solid state lighting fixtures and reflected off at least one of the ceiling and a wall.
